(19) United States
(12) Patent Application Publication
(10) Pub. No.: US 2005/0216314 A1
(43) Pub. Date: Sep. 29, 2005

(54) System supporting exchange of medical data and images between different executable applications

(76) Inventor: Andrew Secor, Paramus, NJ (US)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 11/090,667

(22) Filed: Mar. 25, 2005

Related U.S. Application Data
(60) Provisional application No. 60/557,084, filed on Mar. 26, 2004.

(51) Int. Cl. G06F 17/60

(52) U.S. Cl. 705/3

(57) ABSTRACT

A system, for exchanging medical image data between different processing systems, includes a central repository and an interface. The central repository stores configuration information including entity related information and authorization information. The authorization information associates a user with an indicator of authorization to access particular patient medical records. Multiple different processing systems of corresponding different entities use the configuration information to access medical image data repositories of the corresponding different entities and to enable exchange of medical image data between the different entities. The interface receives, from a first processing system of a first entity, a user initiated request to access a medical image repository of a second processing system of a second entity. The interface accesses the central repository in retrieving configuration information. The interface communicates the retrieved configuration information to the first processing system.

### CROSS-REFERENCE TO RELATED APPLICATIONS

The present application is a non-provisional application of provisional application having Ser. No. 60/557,084 filed by Andrew Secor on Mar. 26, 2004.

### FIELD OF THE INVENTION

The present invention generally relates to computer information systems. More particularly, the present invention relates to a system supporting exchange of medical data and images between different executable applications.

### BACKGROUND OF THE INVENTION

Users of software applications at medical workstations often require access to digital personal medical information, such as image data. The image data is often stored at different computer systems of different organizations or departments, such as a hospital and a remote magnetic resonance imaging (MRI) center, for example. Communication incompatibilities between the different computer systems fail to support a compatible exchange of medical information, including images, in a seamless, compatible manner.

Present computer systems typically communicate medical image data using communications compatible with a Digital Imaging and Communications in Medicine (DICOM) standard. The DICOM standard was created by the National Electrical Manufacturers Association (NEMA) to aid the distribution and viewing of medical images, such as computer tomography (CT) scans, MRIs, and ultrasound. Typically, image files, which are compliant with Part 10 of the DICOM standard, are known as DICOM format files. A single DICOM file contains both a header (which stores information about the patient's name, the type of scan, image dimensions, etc.), as well as the image data (which can contain information in three dimensions).

Internet Protocol (IP) is a data-oriented protocol used by source and destination hosts for communicating data across a packet-switched inter-network. Data in an IP inter-network is sent in blocks referred to as packets or datagrams. In IP, no setup is needed before a host tries to send packets to a host it has previously not communicated with.

Packet switches, or inter-network routers, forward IP packets across interconnected networks. Some of the most complex aspects of IP are addressing and routing. Addressing refers to how end hosts are assigned IP addresses and how subnetworks of IP host addresses are divided and grouped together. IP routing is performed by hosts, but most importantly by inter-network routers, which typically use either interior gateway protocols (IGPs) or external gateway protocols (EGPs) to help make IP packet forwarding decisions across IP connected networks.

An IP address is a unique number, akin to a telephone number, used by machines (e.g., computers) to refer to each other when sending information through the Internet using the Internet Protocol. This allows machines passing the information onwards on behalf of the sender to know where to send it next, and for the machine receiving the information to know that it is the intended destination.

A Domain Name System (DNS) converts an IP address into numerical form from the more human-readable form of domain addresses, such as www.google.com. The process of conversion is known as resolution of the domain name. The DNS is a system that stores information about host names and domain names in a kind of distributed database on networks, such as the Internet. Most importantly, it provides an IP address for each host name, and lists the mail exchange servers accepting e-mail for each domain.

The DNS provides a vital service on the Internet, because while computers and network hardware work with IP addresses to perform tasks such as addressing and routing, humans generally find it easier to work with host names and domain names, for example in universal resource locators (URLs) and e-mail addresses.

Currently, there are two types of IP addresses in active use: IP version 4 (IPv4) and IP version 6 (IPv6). IPv4 was initially deployed on Jan. 1, 1983 and is still the most commonly used version. IPv4 addresses are 32-bit numbers often expressed as four octets in “dotted decimal” notation (e.g., 192.0.32.67). IPv6 was deployed in 1999. IPv6 addresses are 128-bit numbers and are conventionally expressed using hexadecimal strings (e.g., 1080:0:0:0:8:800:200C:417A), thereby providing more addresses than IPv4's 32 bits. Further improvements in IPV6 include the following: simpler header format, flow labeling, improved support for extensions and options, authentication and security extensions, simpler auto-configuration of IP addresses, improved multicast routing, and the addition of any-cast addressing.

Accordingly, there is a need for a system supporting exchange of medical data and images between different executable applications.

### SUMMARY OF THE INVENTION

A system, for exchanging medical image data between different processing systems, includes a central repository and an interface. The central repository stores configuration information including entity related information and authorization information. The authorization information associates a user with an indicator of authorization to access particular patient medical records. Multiple different processing systems of corresponding different entities use the configuration information to access medical image data repositories of the corresponding different entities and to enable exchange of medical image data between the different entities. The interface receives, from a first processing system of a first entity, a user initiated request to access a medical image repository of a second processing system of a second entity. The interface accesses the central repository in retrieving configuration information. The interface communicates the retrieved configuration information to the first processing system.

### BRIEF DESCRIPTION OF THE DRAWINGS

FIG. 1 illustrates a computer information system including an exchange system, a first processing system, and a second processing system.

FIG. 2 illustrates services provided by the exchange system, as shown in FIG. 1.

FIG. 3 illustrates a network diagram of the first processing system, as shown in FIG. 1.

FIG. 4 illustrates an exchange method for use by the exchange system, as shown in FIG. 1.

FIG. 5 illustrates a registrar method for creating unique identifications for an entity, as shown in FIG. 1.

### DETAILED DESCRIPTION OF THE PREFERRED EMBODIMENTS

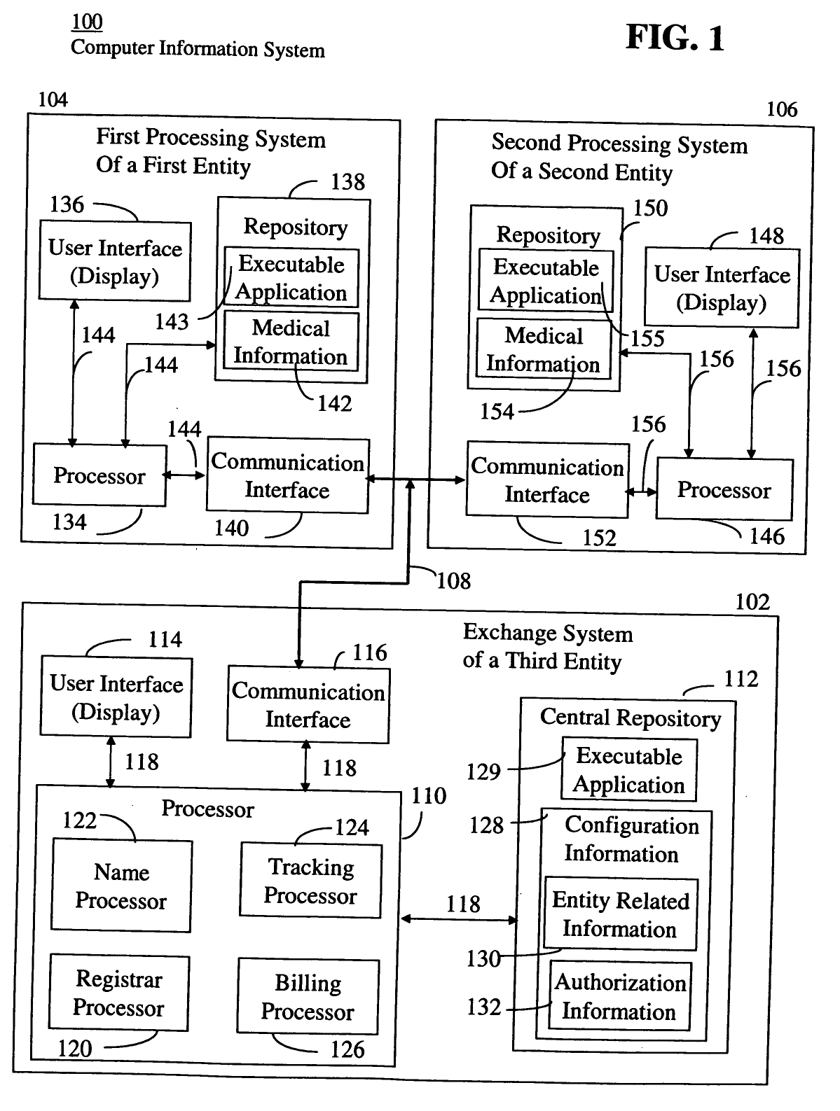

FIG. 1 illustrates a computer information system 100 including an exchange system 102, a first processing system 104, and a second processing system 106, wherein each system 102, 104, and 106 communicates with each other over a communication path 108. The first processing system 104, the second processing system 106, and the exchange system 102 are provided and maintained by first, second, and third entities, respectively.

The exchange system 102 includes a processor 110 for communicating with a central repository 112, a user interface 114, and a communication interface 116 over a communication path 118. The processor 110 further includes a registrar processor 120, a name processor 122, a tracking processor 124, and a billing processor 126. The central repository 112 further includes configuration information 128, including entity related information 130 and authorization information 132, and an executable application 129.

The first processing system 104 includes a processor 134 communicating with a user interface 136, a repository 138, and a communication interface 140 over a communication path 144. The repository 138 further includes medical information 142, such as data and images, for one or more patients, and an executable application 143.

The second processing system 106 includes a processor 146 communicating with a user interface 148, a repository 150, and a communication interface 152 over a communication path 156. The repository 150 further includes medical information 154, such as data and images, for one or more patients, and an executable application 155.

The exchange system 102 supports an exchange of medical information between the first processing system 104 and the second processing system 106. For example, the exchange system 102 supports the first processing system 104 to retrieve medical information 154 from the second processing system 106 for storage in the repository 138 of the first processing system 104. Alternatively, the exchange system 102 also supports the second processing system 106 to retrieve medical information 142 from the first processing system 104 for storage in the repository 150 of the second processing system 106.

The computer information system 100 may be employed by any type of enterprise, organization, or department, such as, for example, providers of healthcare products and/or services responsible for servicing the health and/or welfare of people in its care. For example, each or both of the systems 104 and 106, represent a hospital information system, communicating with the exchange system 102. A healthcare provider provides services directed to the mental, emotional, or physical well being of a patient. Examples of healthcare providers include a hospital, a nursing home, an assisted living care arrangement, a home health care arrangement, a hospice arrangement, a critical care arrangement, a health care clinic, a physical therapy clinic, a chiropractic clinic, a medical supplier, a pharmacy, and a dental office. When servicing a person in its care, a healthcare provider diagnoses a condition or disease, and recommends a course of treatment to cure the condition, if such treatment exists, or provides preventative healthcare services. Examples of the people being serviced by a healthcare provider include a patient, a resident, a client, and an individual.

The exchange system 102 is separate from each of the first and second processing systems 104 and 106, but may be incorporated with one or both systems 104 and 106. For example, the exchange system 102, separate from each of the first and second processing systems 104 and 106, represents an extranet service provider, such as an application service provider (ASP). The separate exchange system 102 advantageously supports the exchange of medical information between unrelated or different entities, such as different hospitals, organizations, subunit of an organization (e.g., departments), users, and groups of workers providing healthcare services, etc.

Each of the systems 102, 104, and 106 may be fixed and/or mobile (i.e., portable), and may be implemented in a variety of forms including, but not limited to, one or more of the following: a personal computer (PC), a desktop computer, a laptop computer, a workstation, a minicomputer, a mainframe, a supercomputer, a network-based device, a personal digital assistant (PDA), a smart card, a cellular telephone, a pager, and a wristwatch. Each of the systems 102, 104, and 106 and/or elements contained therein also may be implemented in a centralized or decentralized configuration, and/or within a collocation hosting arrangement.

Communication paths 108, 144, and/or 156 (otherwise called network, bus, link, connection, channel, etc.) represent any type of protocol or data format including, but not limited to, one or more of the following: an Internet Protocol (IP), a Transmission Control Protocol Internet protocol (TCPIP), a Hyper Text Transmission Protocol (HTTP), an RS232 protocol, an Ethernet protocol, a Medical Interface Bus (MIB) compatible protocol, a Local Area Network (LAN) protocol, a Wide Area Network (WAN) protocol, a Campus Area Network (CAN) protocol, a Metropolitan Area Network (MAN) protocol, a Home Area Network (HAN) protocol, an Institute Of Electrical And Electronic Engineers (IEEE) bus compatible protocol, a Digital and Imaging Communications (DICOM) protocol, and a Health Level Seven (HL7) protocol. In particular, communication path 108 uses, for example, an Internet Protocol compatible with IPv6 and compatible with the DICOM standard. IPV6 also supports mobile IP addressing for notebook and laptop users.

Each of the systems 102, 104, and 106 and/or elements contained therein may be implemented in hardware, software, or a combination of both, and may include one or more processors. A processor, such as processors 110, 134, and 146, is a device and/or set of machine-readable instructions for performing task. A processor includes any combination of hardware, firmware, and/or software. A processor acts upon stored and/or received information by computing, manipulating, analyzing, modifying, converting, or transmitting information for use by an executable application or procedure or an information device, and/or by routing the information to an output device. For example, a processor may use or include the capabilities of a controller or microprocessor.

An executable application, such as executable applications 129, 143, and 155, comprises code or machine readable instruction for implementing predetermined functions including those of an operating system, a healthcare information system, or other information processing system, for example, in response user command or input.

A user interface, such as user interfaces 114, 136, and 148, permits data to be received by or received from a processor. The user interface includes a data input device and a data output device (each not shown). The data input device provides data to the processor in response to receiving input data either manually from a user or automatically from an electronic device, such as a computer. For manual input, the data input device is a keyboard and a mouse, but also may be a touch screen, or a microphone with a voice recognition application, for example. For automatic input, the data input device is a data modem.

The data output device provides data from the processor for use by a user or an electronic device, such as a computer. For output to a user, the data output device is a display that generates display images in response to receiving the display signals from the processor, but also may be a speaker or a printer, for example. For electronic output to an electronic device, the data output device is a data modem. For example, the processor processes the medical image information for reproduction on a display device for viewing by a user.

A repository, such as repositories 112, 138, and 150, represents one or more numbers and/or types of memories, databases, or data storage devices, such as, for example, read only memory (ROM) and/or random access memory (RAM).

The medical information 142 and/or 154 stored in the first 104 and/or second 106 systems, respectively, represents any type of information, including data and images, related to a patient. The data may be in any form including, for example, numerical, alphabetical, graphical, and/or symbolic. The images may be created using any type of technology including, for example, ultrasound technology, nuclear technology, magnetic resonance (MR) technology, computed tomography (CT) technology, positron emission computed tomography (PET) technology, and angiography technology.

The configuration information 128, including the entity related information 130 and the authorization information 132, stored in the exchange system 102 represents unique, secure information that permits one system, such as the first processing system 104, to identify, access, and/or retrieve medical information from another system, such as the second processing system 106. The combination of the entity related information 130 and the authorization information 132 permits one or more users of one system to electronically identify another system, and to access and/or retrieve medical information from the other system. The configuration information 128 may also include at least one of the following: port identifiers, gateway identifiers, subnet addresses, security related information governing access to patient medical information, AET titles, firewall identifiers, packet filtering identifiers, and domain name server (DNS) compatible host names. Trusts between entities and users may be learned in order to conserve network bandwidth, and to allow operation if the exchange system 102 is unreachable due to network outages.

The exchange system 102 assigns each of the systems 104 and 106 unique entity related information 130 to electronically identify and distinguish each system 104 and 106 from each other. The entity related information 130 is representative of a fully qualified domain name (FQDN) permitting the use of public root domain name servers (DNS) on the Internet to achieve successful exchange of medical data and images between the first 104 and second 106 systems. A fully qualified domain name is a dot-separated string of network domains leading back to the root (e.g., archive.hospital.com), having uniqueness appropriate for use as an AET title.

The exchange system 102 assigns one or more users of each system 104 and 106 the authorization information 132 to electronically identify and distinguish one or more users of each system 104 and 106 from each other. The authorization information 132 stored in the exchange system 102 associates a user of one of the systems 104 or 106 with an indicator of authorization to access particular patient medical records, such as medical information 142 and/or 154. The authorization information 132 includes trust information that is stored in repository 138 and 150 with an expiration date to prevent the trusts from getting stale. The central repository 112 sends a security message to a user of one of the systems 104 or 106 indicating that the user is authorized or unauthorized to access particular medical image data of a particular patient in response to examining the authorization information 132. For example, the exchange system 102 authorizes a user of the first processing system 104 to access medical information 154 of a particular patient stored in the repository 150 of the second processing system 106. Likewise, for example, the exchange system 102 authorizes a user of the second processing system 106 to access medical information 142 of a particular patient stored in the repository 138 of the first processing system 104.

The exchange system 102 may grant or deny (i.e., inhibit) a user's access to a patient's medical information in response to an evaluation of the authorization information 132. For example, if a user's electronic identity matches the indicator of authorization in the authorization information 132, then the exchange system 102 grants the user access to the patient's medical information. Alternatively, for example, if a user's electronic identity does not match the indicator of authorization in the authorization information 132, then the exchange system 102 denies the user access to the patient's medical information.

A communication interface, such as communication interfaces 116, 140, and 152, permit at least two systems to communicate over the communication path 108. The communication interface may be implemented with any combination of hardware, firmware, and/or software. The communication interfaces 116, 140, and 152 are compatible with the communication path 108 between the systems 102, 104, and 106, and compatible with the communication paths 118, 144, and 156, respectively, inside the systems 102, 104, and 106, respectively.

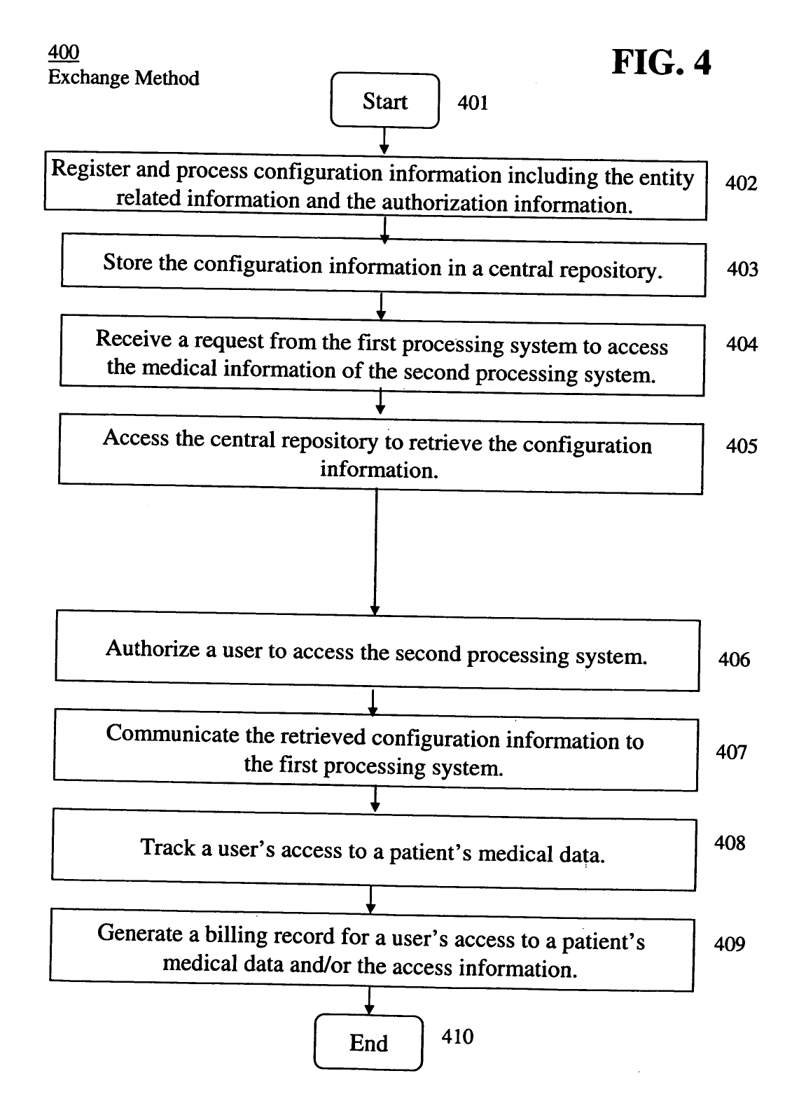

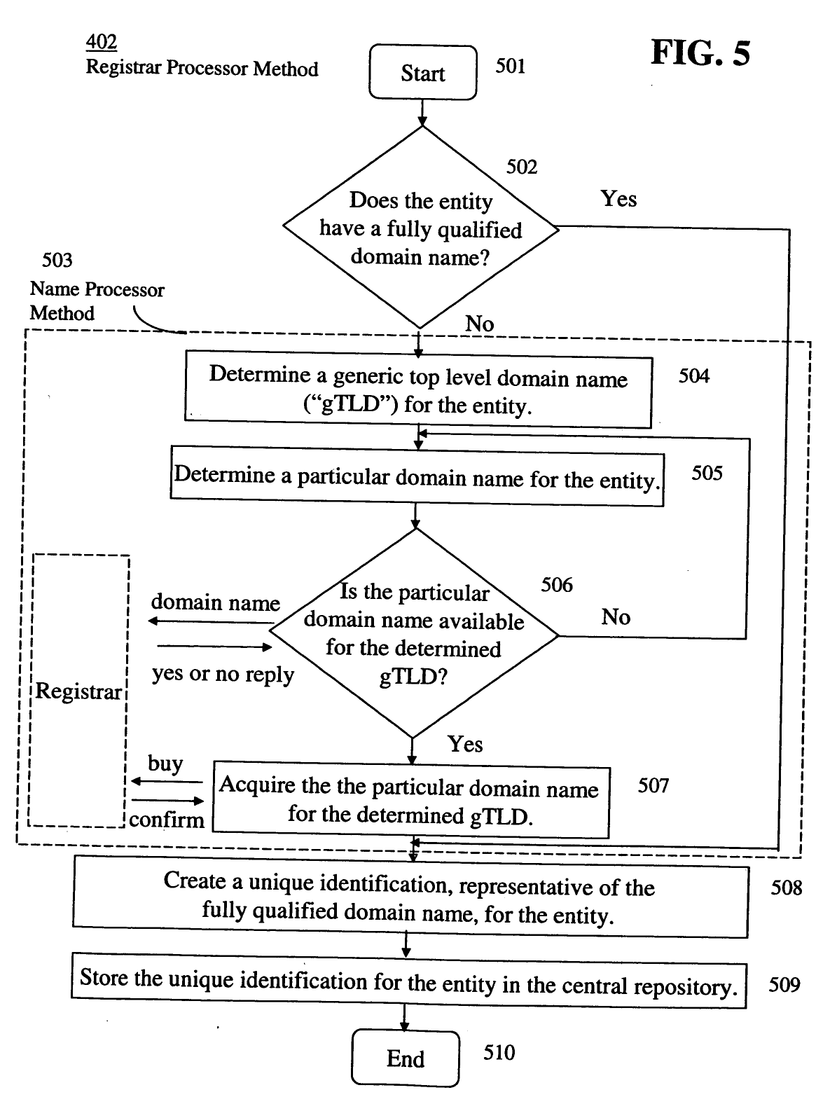

The registrar processor 120 performs a method as shown in step 402 in FIG. 4, which is further described in FIG. 5. The name processor 122 performs a method as shown in step 503 in FIG. 5. The tracking processor 124 monitors and maintains a record of a user's access to the medical information of a particular patient. The maintained record contains, for example, Health Insurance Portability And Accountability Act (HIPAA) compliant monitoring information. The billing processor 126 monitors and generates a record used for billing for access by a user of at least one of the following: the medical information 142 and/or 154 of a particular patient, the ICANN accredited registrar's fee for leasing a FQDN 507, and the configuration information 128.

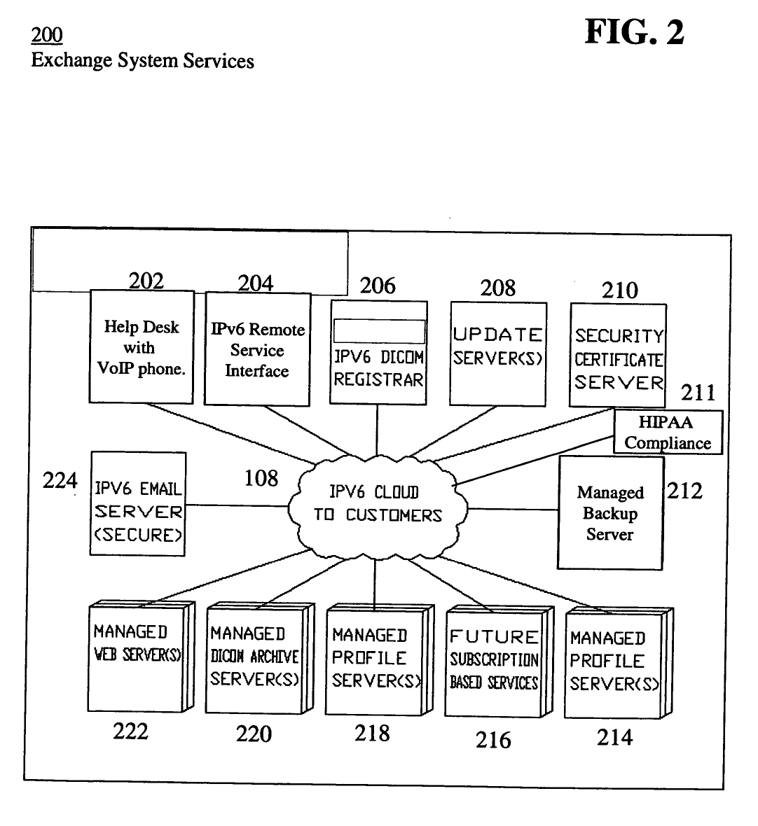

FIG. 2 illustrates services 200 provided by the exchange system 102, as shown in FIG. 1. Services 200 include, for example, a help desk 202, IPv6 remote service 204, IPv6 DICOM registrar 206, updates 208, security certificates 210, HIPAA compliance 211, managed backups 212, managed profiles 214 and 218, subscription based services 216, managed DICOM archives 220, managed web servers 222, and IPv6 secure Email 224. The exchange system 102 provides the services 200 to the first and/or second processing systems 104 and 106 via the communication path 108, graphically represented as an “IPv6 cloud” in FIG. 2.

The help desk 202 permits a user to quickly resolve problems with the exchange system 102. The help desk 202 directs a user to a source of immediate help of an appropriate department in the exchange system 102 (e.g., applications, system administrator, image management administration, sales, etc.). The help desk 202 supports voice over IP telephony, secure email, instant messaging, and computer session management.

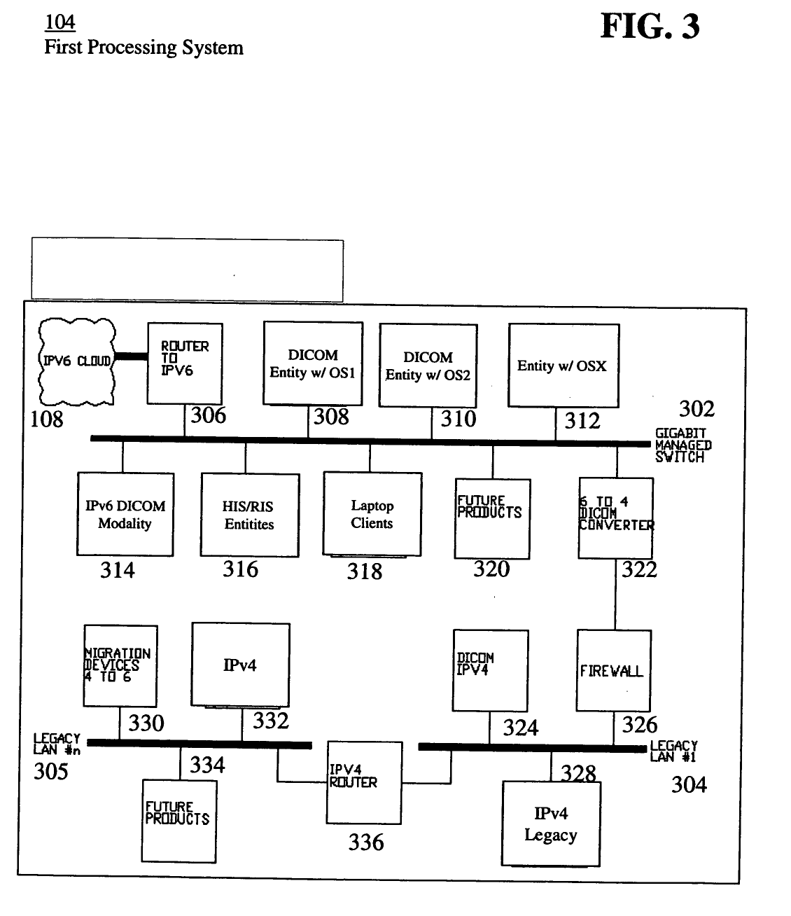

The IPv6 remote service (RS) interface 204 provides detailed connectivity information for remote service capability. Technical support computers and/or personnel remotely monitor any of the elements, as shown in FIG. 3, which are located at client or customer locations. These devices are managed, tested, and/or updated as required by authorized individual(s) with HIPAA compliance recorded by the HIPAA compliance service 211. The help desk service 202 initially receives a client request by voice over IP call, email, or instant message, and routes IPv6 RS 204 attention to the appropriate department (e.g., sales, service, applications, etc.) of the service provider. Automated reporting is a feature of IPv6 RS interface 204, wherein an element in FIG. 2 or FIG. 3 automatically reports system information (e.g., event logs) back to the IPv6 RS interface 204 for predictive and proactive maintenance, faster problem solution, improved problem analysis, and statistical generation of computer information system 100 reports.

The IPv6 DICOM registrar 206 manages the DICOM IPv6 configuration information 128. The IPv6 DICOM registrar 206 works in a similar fashion to an Internet domain name registrar providing DNS functions. The exchange system 102 advantageously provides a fully qualified domain name on individual host systems 104 and/or 106 in combination with IPv6 protocol and DICOM standard protocol. The name processor 122 and the registrar processor 120 work together, as described in FIG. 5, to generate for each entity its own unique computer name. This name is special, because it is resolved into an IP address on the worlds root level domain name servers. Once the domain name is acquired (e.g., step 507 in FIG. 5) and configured by the ICANN accredited registrar, the Ipv6 DICOM registrar 206 forms a unique identification representative of the FQDN in step 508 of FIG. 5, and stores it as part of the entity related information 130. The unique name now replaces the current application entity title (AET) in existing Ipv4 DICOM configurations as a principle identifier of the individual host systems 104 and/or 106. Employing the FQDN insures globally unique naming for entities 104 and/or 106. The registrar 206 also provides configuration management functions including a registrar service enabling authorized users to login to central repository 112 for creating and modifying user authorization information 132. All standard DICOM communication data is also embedded into the entity related information 130 of the central repository 112. User interfaces 114, 136, or 148 are used to enter standard DICOM information once authorization information 132 is satisfied.

The updates 208 provide remotely managed operating system (OS) updates, for example, application software or firmware updates. These updates are managed specific to each type of the processing systems 104. The updates are applied on a scheduled basis to avoid interference with the users schedule.

The security certificates 210 enable authentication. A central server acts as a certificate authority (CA) to provide digital keys for use with the authorization information 132 to authenticate entities, shown in FIG. 2 and FIG. 3, and users (with or without human authentication (HA)). Human authentication includes, for example, a fingerprint sensor or a retinal scan for biometric authentication. The system may also use any PKI design or smart card use. The security certificate 210 is also used for encrypting data in any repository 112, 138, and/or 150, or as needed by future subscription services 216.

The HIPAA compliance 211 tracks and monitors access to patient medical information and other confidential information. The HIPAA compliance 211 addresses HIPAA requirements, and creates and maintains a matrix of allowed and disallowed image files in one or more repositories. Authorization information 132 will additionally restrict movement of repository data, or allow movement where trusts are established. A trust may be established between organizations with a signed business associate agreement (BAA). The HIPAA compliance 211 may offer online (BAA) agreements to be signed electronically and store the records for authorized users to promote effective exchange of medical data and images between different executable applications.

The managed backups 212 provide remote managed backup services for disaster recovery. Entities shown in FIG. 3 may have OS back-ups, application back-ups, etc. stored by the service provider for use in the event of system failures of the processing system 104 and/or 106.

The managed profiles 214 provide client devices in FIG. 3 with the customized application layouts and preferences based on that user's identity. This allows the user to login to any client device, and have the same environment variables loaded on that machine type.

The managed profiles 218 serve the same purpose as the managed profiles 214, but support a high level profile for a hospital administrator, for example. For example, managed profiles 218 supports information for automated workflows, and for a radiologist's workstation for programming swift and efficient image routing, report routing, and billing routing.

The subscription-based services 216 provide the sale of subscriptions for the various services provided by the exchange system 102. The subscription-based services 216 includes a transaction billing system for automatically billing users on a per transaction fee.

The managed DICOM archives 220 provide a client with a remote or transparent backup copy of an element in FIG. 3, which is offsite in a data center environment/or collocation hosting environment, therefore meeting disaster recovery goals and/or creating network load balancing for performance advantages. This also permits sales demonstrations of any DICOM entity with a partner DICOM entity on site.

The managed web servers 222 provide web sites for the first 104 and/or second 106 system. This is another example of a DICOM entity cooperating with processing system 104 or 106. Subscribing customers may also use this web space for purposes beyond DICOM communications, if desired, as this space can be represented as universal resource locator (URL) addresses within Ipv6 space for general hosting service(s).

The IPv6 Email 224 provides secure email communications between the exchange system 102 and the first 104 and/or second 106 system.

A DICOM time server (not shown) that is compatible with standard network time protocol (NTP) synchronizes the exchange system 102 with the first 104 and/or second 106 processing systems to provide accurate data reporting. The DICOM time server also reports devices that fail to respond in a predetermined time, such as an eight-hour period (e.g., for each daily shift change) to the help desk 202.

The systems 104 and/or 106 of different entities (e.g., users, departments, organizations etc.) use a central repository 112 of communication configuration information 128 supporting transfer of medical images and data 142 and/or 154 using IPv6 protocol or another protocol, for example. The exchange system 102 provides improved security, centralized configuration capability, new services, and improved support. The centralized repository 112 of configuration information 128 in combination with use of the IPv6 protocol and the DICOM standard, for example, enables management services to be offered with higher security against viruses and worms, better manageability of computers, and easier configuration. The Ipv6 cloud 108 provides a “flat,” simpler network topology compared with Ipv4, wherein each system 104 and/or 106 accesses the exchange system 102 without the need of network address translation (NAT) via private networks. The network topology advantageously improves system operation over the fragmented network topologies typically in use at hospitals, for example. The centralized repository 112 is electronically centralized for addressing and access, but may be physically implemented as one or more distributed databases.

FIG. 3 illustrates a network diagram 300 of the first processing system 104, as shown in FIG. 1. A network diagram 300 of the second processing system 106 (not shown) may have the same or similar elements as the network diagram 300 of the first processing system 104. The network diagram 300 includes a gigabit managed switch 302, a legacy LAN #1, and a legacy LAN #N. One aspect of the switch 302 is the ability to form a virtual LAN (VLAN) to firewall protect the processing systems 104 and/or 106, by defining what source IP addresses may pass thru the switch 302. The central repository 112 knows all network partners who may exchange data via the switch 302, thus preventing spread of Internet virus or worms. The network diagram 300 shows devices proposed for sale/lease at customer locations.

Elements coupled to the gigabit managed switch 302 include the following: a router to IPv6 306 coupled to the IPv6 cloud 108, a first DICOM entity with a first operating system (OS) 308, a second DICOM entity with a second OS 310, an entity with OS #x 312, an IPv6 DICOM modality 314, IUS/RIS entities 316, laptop clients 318, future products 320, and an IPV6 to IPV4 DICOM converter 322. The gigabit-managed switch 302 is remotely configured to offer security and block IPv4 traffic. The first processing system 104 offers improved performance by using gigabit switching and certified installation of network and computing devices to insure a high rate of availability.

Elements, coupled to the legacy LAN #1 304, include the following: a DICOM IPV4 324, a firewall 326 coupled to the converter 322, and proprietary IPV4 legacy products 328.

Elements, coupled to the legacy LAN #N 305, include the following: IPV4 to IPV6 migration devices 330, proprietary IPV4 products 332, and future products 334. An IPV4 router 336 couples the legacy LAN #1 304 to the legacy LAN #N 305.

FIG. 4 illustrates an exchange method 400 for use by the exchange system 102, as shown in FIG. 1.

The method starts at step 401.

At step 402, the exchange system 102 registers and processes configuration information 128, including the entity related information 130 and the authorization information 132.

At step 403, the exchange system 102 stores the configuration information 128 in the central repository 112.

At step 404, the exchange system 102 receives a user initiated request from the first processing system 104 to access the medical information 154 stored in the repository 150 in the second processing system 106.

At step 405, the exchange system 102 accesses the central repository 112 to retrieve the configuration information 128.

At step 406, the exchange system 102 authorizes a user of the first processing system 104 to access medical information 154 on the second processing system 106.

At step 407, the exchange system 102 communicates the retrieved configuration information 128 to the first processing system 104.

At step 408, the exchange system 102 tracks a user's access to a patient's medical information 154 using the tracking processor 124.

At step 49, the exchange system 102 generates a billing record for a user's access to a patient's medical information 154 and/or the configuration information 128 using the billing processor.

At step 410, the method ends.

FIG. 5 illustrates a registrar method 402 for creating unique identifications for an entity 104 and/or 106, shown in FIG. 1. FIG. 5 provides further details of the step 402, as shown in FIG. 4.

The method starts at 501.

At step 502, the registrar processor 120 determines whether an entity has a fully qualified domain name. If the determination at step 502 is positive, then the method continues to step 508. Otherwise, if the determination at step 502 is negative, then the method continues to step 504.

At step 503, the registrar processor 120 determines and acquires a generic Top Level Domain (gTLD) (e.g., .com, .org, .net) and a particular domain name for the entity. The registrar processor 120 performs step 503 alone or in cooperation with the entity. Step 503 includes steps 504 to 507. At step 504, the name processor 122 determines a generic Top Level Domain (gTLD) for the entity.

At step 505, the name processor 122 determines a particular domain name for the entity.

At step 506, the name processor 122 determines whether the particular domain name is available for the generic Top Level Domain (gTLD). The name processor 122 makes the determination by communicating with a registrar. The name processor 122 sends the particular domain name for the gTLD to the registrar. The registrar checks the availability for the particular domain name for the gTLD, and provides a yes or no reply as to the availability back to the name processor 122. If the determination at step 506 is negative, then the method returns to step 505 to determine another particular domain name for the entity. Otherwise, if the determination at step 506 is positive, then the method continues to step 507.

At step 507, the name processor 122 acquires the particular domain name for the determined gTLD from the registrar via a purchase and confirmation transaction with the registrar.

At step 508, the registrar processor 120, in cooperation with the name processor 122, creates a unique identification, representative of the FQDN, for the entity. The unique identification advantageously permits each processing system to be identified by the exchange system 102 at the entire entity level rather than at a private level internal to the entity. Hence, the unique identification simplifies the operation of the exchange system 102 and simplifies the network connections and communication between the exchange system 102 and the processing system 104 and/or 106.

At step 509, the registrar processor 120 stores the unique identification for the entity in the central repository 112.

At step 510, the method ends.

Hence, while the present invention has been described with reference to various illustrative embodiments thereof, the present invention is not intended that the invention be limited to these specific embodiments. Those skilled in the art will recognize that variations, modifications, and combinations of the disclosed subject matter can be made without departing from the spirit and scope of the invention as set forth in the appended claims.

1. A system for exchanging medical image data between different processing systems, comprising:
a central repository of configuration information, including entity related information and authorization information, associating a user with an indicator of authorization, to access particular patient medical records, for use by a plurality of different processing systems of corresponding different entities, the repository being used in accessing medical image data repositories of the corresponding different entities and enabling exchange of medical image data between the different entities; and
an interface for,
receiving, from a first processing system of a first entity, a user initiated request to access a medical image repository of a second processing system of a second entity,
accessing the central repository to retrieve configuration information, and
communicating the retrieved configuration information to the first processing system.

2. A system according to claim 1, including:
a registrar processor for registering and processing the configuration information.

3. A system according to claim 1, wherein
the entity related information is mutually different and compatible with IPv6 protocol.

4. A system according to claim 1, including:
a name processor for determining and acquiring a fully qualified domain name for the entity related information.

5. A system according to claim 1, wherein
the configuration information includes mutually different entity related information for use by the plurality of different processing systems of corresponding different entities preventing conflict among the different entities.

6. A system according to claim 1, wherein
the configuration information includes authorization information, associating a user with an indicator of authorization, to access particular patient medical records stored by a plurality of different processing systems of corresponding different entities enabling a user of a first entity to access medical image data stored by a second entity.

7. A system according to claim 1, including
a tracking processor for monitoring and maintaining a record of access by a user of patient medical data of a particular patient.

8. A system according to claim 1, wherein
the maintained record contains HIPAA compliant monitoring information.

9. A system according to claim 1, wherein
an entity comprises at least one of, (a) an organization, (b) a sub unit of an organization, (c) a user, and (d) a group of workers providing healthcare services.

10. A system according to claim 1, wherein
the entity related information further comprises domain name server (DNS) compatible host names.

11. A system according to claim 1, wherein
the configuration information includes, for use by a plurality of different processing systems of corresponding different entities, at least one of the following: (a) port identifiers, (b) gateway identifiers, (c) subnet addresses, and (d) security related information governing access to patient medical image data.

12. A system according to claim 1, wherein
the configuration information includes, for use by a plurality of different processing systems of corresponding different entities, at least one of the following (a) AET titles, (b) firewall identifiers and (c) packet filtering identifiers.

13. A system according to claim 1, wherein
the configuration information for use by a plurality of different processing systems of corresponding different entities, includes a domain name server (DNS) compatible host name.

14. A system according to claim 1, including
a billing processor for monitoring and generating a record used for billing for access by a user of at least one of the following: (a) patient medical data of a particular patient, and (b) the configuration information.

15. A system according to claim 1, wherein
the central repository comprises a plurality of different databases.

16. A system according to claim 1, wherein
the user initiated request is to access particular medical image data of a particular patient, and
the interface inhibits communication of the configuration information to the first processing system in response to a determination from examination of the indicator the user is unauthorized to access the particular medical image data of the particular patient.

17. A system for use by a processing system in accessing medical image data stored by a second different processing system, comprising:
a communication interface of a first processing system of a first entity for:
communicating a user initiated request message to access particular medical image data of a particular patient in a repository of a second processing system of a second entity,
in response to the communicated request, receiving, from a central repository, configuration information, including entity related information, for use in accessing the particular medical image data of the particular patient in the repository of the second processing system,
using the received entity related information in acquiring the medical image data of the particular patient in the repository of the second processing system, and
an image data processor for storing the medical image data of the particular patient in a repository of the first processing system.

18. A system according to claim 17, wherein
in response to the communicated request message, the communication interface receives, from the central repository, a security message indicating the user is unauthorized to access the particular medical image data of the particular patient, the un-authorization determination being derived in response to examination of authorization information maintained by the central repository.

19. A system according to claim 17, wherein
the image data processor processes the medical image data for reproduction on a display device for viewing by a user.

20. A method comprising the steps of:
creating a unique identification, representative of a fully qualified domain name, for each one of a plurality of different processing systems of corresponding different entities to permit each one of a plurality of different processing systems to access information stored in the plurality of different processing systems; and
storing the unique identification for each one of the plurality of different processing systems in a central repository.

21. A method according to claim 20, further comprising the steps of:
receiving a request from a first processing system corresponding to a first entity to access information stored in a second processing system corresponding to a second entity;
accessing the central repository to retrieve the unique identification associated with the second processing system; and
communicating the retrieved unique information to the first processing system.

22. A method according to claim 21, further comprising the step of:
tracking the request from the first processing system.

23. A method according to claim 22, further comprising the step of:
generating a billing record for the request from the first processing system.
